(19) United States
(12) Patent Application Publication
(10) Pub. No.: US 2017/0061456 A1
(43) Pub. Date: Mar. 2, 2017

(54) TALENT FLOW VISUALIZATION

(71) Applicant: Linkedln Corporation, Mountain View, CA (US)

(72) Inventors: Yi Feng, Sunnyvale, CA (US); Dong Li, Sunnyvale, CA (US); Weizhen Wang, San Jose, CA (US)

(21) Appl. No.: 14/835,141

(22) Filed: Aug. 25, 2015

(51) Int. Cl. G06Q 30/02; G06F 3/0481; G06F 3/0482; G06Q 50/00; G06F 3/0484

(52) U.S. Cl. CPC G06Q 30/0204; G06Q 50/01; G06F 3/04842; G06F 3/0482; G06F 3/04847; G06F 3/04817; G06F 3/04812

(57) ABSTRACT

A social network can visually display talent flow among companies, for example, employees that have reported to the social network leaving one company and joining another company within a specified time window. A processor can retrieve talent flow data, create a visual representation of the talent flow, and provide the visual representation to the user. The visual representation can show the plurality of companies as nodes. The visual representation can show a presence of talent flow between a pair of companies as an edge connecting a respective pair of nodes. The visual representation can show a degree of the talent flow between the pair of companies as a talent flow icon disposed along the respective edge. Each talent flow icon can be sized according to a company size, and positioned along a respective edge to indicate an aggregated direction of talent flow between the pair of companies.

### BACKGROUND

A social network system is a computer or web-based service that enables users to establish links or connections with persons for the purpose of sharing information with one another. Some social network systems aim to enable friends and family to communicate and share with one another, while others are specifically directed to business users with a goal of establishing professional networks and sharing business information. For purposes of the present disclosure, the terms “social network” and “social network system” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows a diagram of a social network service, in accordance with some examples.

FIG. 2 shows an example of a visual representation, in accordance with some examples.

FIG. 3 shows an example of a visual representation responding to a cursor hovering over a talent flow icon, in accordance with some examples.

FIG. 4 shows an example of a visual representation responding to a cursor clicking on a talent flow icon, in accordance with some examples.

FIG. 5 shows an example of a visual representation responding to a cursor hovering over a node, in accordance with some examples.

FIG. 6 shows an example of a method for visually displaying talent flow among companies, where the companies have employees that are members of a social network, in accordance with some examples.

FIG. 7 illustrates a block diagram of an example of a machine upon which any one or more of the techniques (e.g., methodologies) discussed herein may perform.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business network system. The present inventive subject matter is generally applicable to a wide range of information services.

A social network system is a service provided by one or more computer systems accessible over a network that allows members of the service to build or reflect social networks or social relations among members. Typically, members construct profiles, which may include personal information such as the member's name, contact information, employment information, photographs, personal messages, status information, multimedia, links to web-related content, blogs, and so on. In order to build or reflect these social networks or social relations among members, the social network system allows members to identify and establish links or connections with other members. For instance, in the context of a business network system (a type of social network system), a person may establish a link or connection with his or her business contacts, including work colleagues, clients, customers, personal contacts, and so on. With a social network system, a person may establish links or connections with his or her friends, family, or business contacts. While a social network system and a business network system may be generally described in terms of typical use cases (e.g., for personal and business networking, respectively), it will be understood by one of ordinary skill in the art that a business network system may be used for personal purposes (e.g., connecting with friends, classmates, former classmates, and the like) as well as or instead of business networking purposes and a social network system may likewise be used for business networking purposes as well as or in place of social networking purposes. A connection may be formed using an invitation process in which one member invites a second member to form a link. The second member then has the option of accepting or declining the invitation.

In general, a connection or link represents or is otherwise associated with an information access privilege, such that a first person who has established a connection with a second person is, via the establishment of that connection, authorizing the second person to view or access certain non-publicly available portions of their profiles that may include communications they have authored. Example communications may include blog posts, messages, wall postings, or the like. Depending on the particular implementation of the business/social network system, the nature and type of the information that may be shared, as well as the granularity with which the access privileges may be defined to protect certain types of data, may vary greatly.

Some social network systems may offer a subscription or following process to create a connection instead of or in addition to the invitation process. A subscription or following model is where one member follows another member without the need for mutual agreement. Typically in this model, the follower is notified of public messages and other communications posted by the member that is followed. An example social network system that follows this model is Twitter®, which is a micro-blogging service that allows members to follow other members without explicit permissions. Other, connection based social network systems also may allow following type relationships as well. For example, the social network system LinkedIn® allows members to follow particular companies.

It can be beneficial to track talent flow among companies, for example, employees that have left one company and joined another company within a specified time window. Such talent flow data can be used for targeting companies from which to recruit new employees, for job-seekers, or for business analysts, who are trying to determine if a particular company will lay off employees or make other business-related decisions. Unfortunately, tracking talent flow can be technically difficult or impossible using just data provided by press coverage or by the companies themselves. In some examples, even if talent flow data were available, displaying the talent flow data can be technically challenging.

In a technical solution to the above technical problem, a social network can visually display talent flow among companies, for example, employees that have reported to the social network leaving one company and joining another company within a specified time window. A processor can retrieve talent flow data, create a visual representation of the talent flow, and provide the visual representation to the user.

The visual representation can show the plurality of companies as nodes. The visual representation can show a presence of talent flow between a pair of companies as an edge connecting a respective pair of nodes. The visual representation can show a degree of the talent flow between the pair of companies as a talent flow icon disposed along the respective edge. Each talent flow icon can be sized according to a company size, and positioned along a respective edge to indicate an aggregated direction of talent flow between the pair of companies.

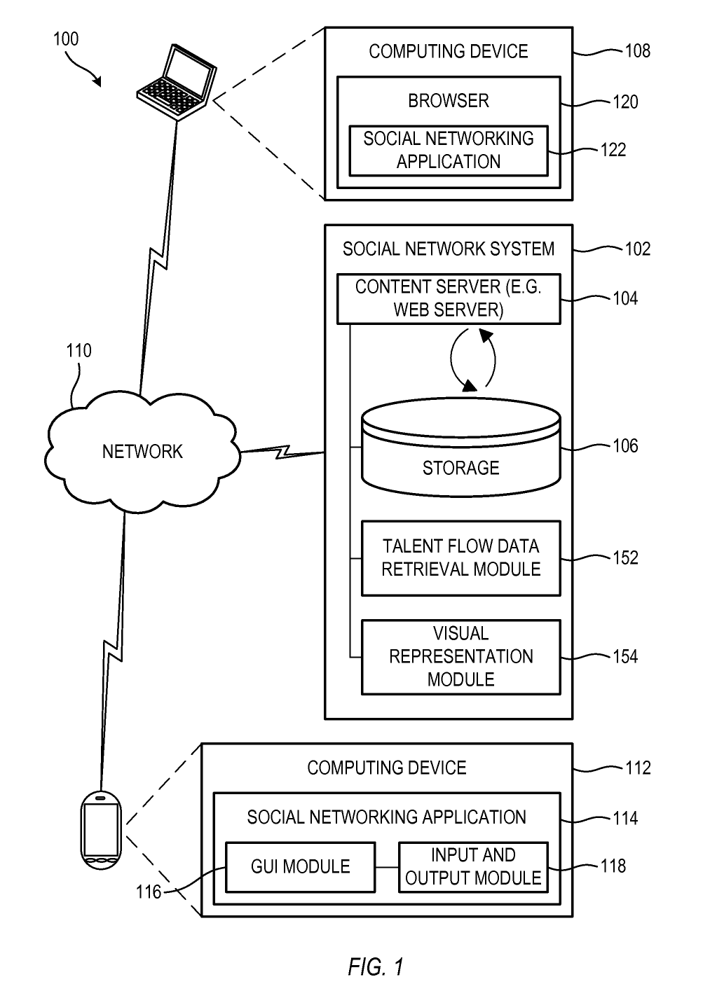

FIG. 1 shows a diagram of a social network service 100, in accordance with some examples. Social network system 102 may contain a content server 104. Content server 104 may communicate with storage 106 and may communicate with one or more computing devices 108 and 112 through a network 110. Content server 104 may be responsible for the retrieval, presentation, and maintenance of member profiles stored in storage 106 as well as the retrieval, creation, and presentation of a user interface for users. Content server 104 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 108. The content server 104 may also be responsible for allowing members to communicate with one another, establish connections, and post multi-media files (e.g., pictures, videos, and the like).

Users of computing devices 108 and 112 may include one or more members, prospective members, or other users of the social network system 102. Computing devices 108 and 112 communicate with social network system 102 through a network 110. The network may be any means of enabling the social network system 102 to communicate data with computing devices 108, 112. Example networks 110 may be or include portions of one or more of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Computing device 108 may be a laptop, desktop, tablet, cellphone or any other computing device which may provide a social networking application 122 in conjunction with browser 120. Social networking application 122 may be one or more of hypertext markup language (HTML), JavaScript, Java, or other browser executable objects that are executed within the browser 120 to provide social networking functionality to a user. The social networking application 122 may be deployed to the computing device 108 by content server 104 through interaction with browser 120.

Computing device 112 may be a laptop, desktop, tablet, cellphone, or any other computing device which may provide a social networking functionality to the user through execution of a social networking application 114. Social networking application 114 may include a graphical user interface (GUI) module 116 which may provide a graphical user interface output to a display which may show social networking information. Input and output module 118 may accept input and process it in order to update the graphical user interface provided by the GUI module 116. Input and output module 118 may interface with the social network system 102 through the content server 104 using one or more application programming interfaces (APIs). For example input and output module may receive data related to the social network system (e.g., member profile information, GUI information, and other data) by interfacing through one or more application programming interfaces (APIs).

Both social networking applications 122 and 114 may provide social networking functionality to users in conjunction with content server 104, and in some examples in conjunction with storage 106. Social networking functionality may include viewing, editing, or deleting information in member profiles, communicating with other members, adding or removing skills, and the like.

The social network system may include various modules, connected to the content server 104 and storage 106, which may prompt a user or member and receive input from the user or member. In response to a selection of a selected company on a user interface provided to a user, the modules may retrieve, from the social network, talent flow data relating a plurality of companies to one another, the plurality of companies including the selected company, create a visual representation, from the retrieved talent flow data, showing the plurality of companies as nodes and showing relationships among the plurality of companies as edges connecting the nodes and provide the visual representation to the user.

A talent flow data retrieval module 152 may retrieve, from the content server 104, talent flow data relating a plurality of companies to one another, where the plurality of companies includes the selected company. In some examples, the talent flow data can include talent flow between companies. In some examples, talent flow can represent employees leaving one company and joining another company. In some examples, talent flow may include employees that have reported to the social network leaving one of the plurality of companies and joining another of the plurality of companies within a specified time window. These are but a few examples; other suitable data may also be retrieved.

A visual representation module 154 may receive data retrieved from the talent flow data retrieval module 152, and may create a visual representation of the retrieved data on a user interface. In some examples, the visual representation may be a force-directed graph drawing in which an edge connecting first and second nodes has a length that varies inversely with strength of the talent flow between first and second companies corresponding to the first and second nodes. This is but one example; other suitable visual representations may also be used.

In some examples, the social network service 100 can execute a method for visually displaying talent flow among companies, where the companies can have employees that are members of a social network.

In the method, at least one processor can receive a selection of a selected time frame on a user interface provided to a user. In some examples, the time frame can include a selectable month of a selectable year. In the method, the processor can receive a selection of a selected industry on the user interface provided to the user. In some examples, the user interface can provide a menu of selectable industries, such as education, information technology, finance, legal, and so forth. In some examples, the user interface can include one or more filters, which can allow selection of one or more companies on an established list, such as the S&P 500, or others.

In the method, the processor can retrieve, from the social network, talent flow data relating a plurality of companies to one another, where the plurality of companies can be categorized within the selected industry. In some examples, talent flow can represent employees leaving one company and joining another company. In some examples, talent flow may include employees that have reported to the social network leaving one of the plurality of companies and joining another of the plurality of companies within a specified time window. In some examples, the number of employees employed by the first company may include a number of members of the social network that indicate on the social network that they are employed by the first company at the end of the specified time window. Similarly, in some examples, the number of employees employed by the second company may include a number of members of the social network that indicate on the social network that they are employed by the second company at the end of the specified time window. In other examples, the social network may use additional data to determine the size of the first and/or second company. The additional data may include one or more values obtained from sources such as company websites, company annual reports, and other company literature, and entered into the social network. In some examples, the retrieved talent flow data can be compiled monthly, rather than assembled in real time. In other examples, the retrieved talent flow data can be assembled in real time.

In the method, the processor can create a visual representation, from the retrieved talent flow data, showing the plurality of companies as nodes, showing a presence of talent flow between a pair of companies, of the plurality of companies, within the selected time frame, as an edge connecting a respective pair of nodes, and showing a degree of the talent flow between the pair of companies as a talent flow icon disposed along the respective edge. The visual representation is discussed below in detail.

In the method the processor can provide the visual representation to the user, such as on a user interface, such as on a web browser. During use, in response to a user's selection of a selected company on a user interface, the social network may display all or part of the visual representation on all or a portion of the user interface.

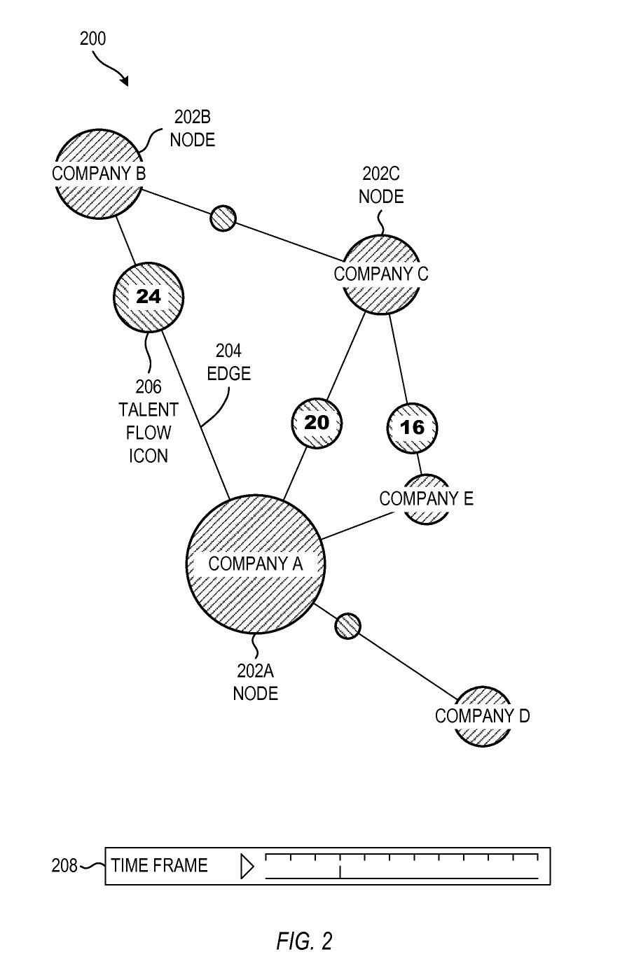

FIG. 2 shows an example of a visual representation 200, in accordance with some examples. In some examples, during use, a social network service can retrieve talent flow data from a server, can generate the visual representation 200 from the retrieved talent flow data, and present the visual representation 200 to a user on a user interface, such as in a web browser. In some examples, the visual representation 200 can include one or more interactive elements that can be selected by a user through the user interface, and/or one or more elements that can move within the user interface through animation. FIG. 2 is but one example of a visual representation 200; other suitable visual representations can also be used.

Visual representation 200 can show a plurality of companies as nodes 202A-C. In some examples, the companies shown in FIG. 2 can represent the largest companies in the selected industry at the time of the selected time frame. In some examples, such a time can be at a beginning of the selected time frame, at an end of the selected time frame, at a point in the middle of the selected time frame, or averaged over the time frame. There are several available metrics that can be used to determine company size, such as a number of employees at the time of the selected time frame, a market capitalization at the time of the selected time frame, and others. For instance, U.S. patent application Ser. No. 14/804,127 discusses an enhanced employee turnover rate, which can be used as an indicator reflecting a company's size and/or structural stability. U.S. patent application Ser. No. 14/804,127 is hereby incorporated by reference in its entirety. In some examples, the nodes 202A-C can be sized according to company size at the time of the selected time frame. In some examples, a company may not be shown in FIG. 2 if no employees left the company to join another company in FIG. 2, or joined the company from another company in FIG. 2, in the selected time frame. In some examples, to avoid excessive detail, visual representation 200 can limit the number of companies to a threshold value, such as 50. In the specific example of FIG. 2, visual representation 200 displays just five companies, denoted as companies A through E. In the specific example of FIG. 2, visual representation 200 displays nodes 202A-C as shaded circles; in other examples, other suitable shapes and shading patterns can also be used.

Visual representation 200 can show a presence of talent flow between a pair of companies, of the plurality of companies, within the selected time frame, as an edge 204 connecting a respective pair of nodes 202A-B. In some examples, the edges 204 can be straight lines connecting the nodes 202A-B. In other examples, the edges 204 can be formed from a plurality of joined line segments. In still other examples, one or more portions of an edge 204 can be curved.

Visual representation 200 can show a degree of the talent flow between the pair of companies as a talent flow icon 206 disposed along the respective edge 204. In the specific example of FIG. 2, talent flow icon 206 shows a degree of talent flow between companies A and B, in the selected time frame. In some examples, the talent flow icon 206 can be based on employees going in either direction. In other examples, the talent flow icon 206 can be based on employees going in just one direction. In other examples, there can be multiple talent flow icons 206 along an edge 204, with one for each direction.

In some examples, each talent flow icon 206 can be sized according to an aggregate number of employees exchanged between a respective pair of companies, in the selected time frame. For example, this aggregate number of exchanged employees can include a number of employees that left one of the pair of companies to join the other of the pair of companies, in the selected time frame. In the specific example of FIG. 2, twenty-four employees switched employment between companies A and B, in the selected time frame. Talent flow icon 206 can be larger than comparable talent flow icons that represent fewer exchanged employees, such as sixteen or twenty. In some examples, for relatively large talent flow icons 206, visual representation 200 can additionally display a numeral with the talent flow icons 206; such numerals can be omitted for relatively small talent flow icons 206 to reduce clutter in the visual representation 200. In the specific example of FIG. 2, talent flow icons 206 are circular; other suitable shapes can also be used. In some examples, the talent flow icons 206 can be shaded with a color different from the color of the nodes 202A-C; other suitable shading patterns can also be used.

In some examples, each talent flow icon 206 can be positioned along the respective edge 204 to indicate an aggregated direction of talent flow between the pair of companies, in the selected time frame. For example, the aggregated direction can include a direction and strength of a net flow of employees from one of the pair of companies to the other of the pair of companies, in the selected time frame. In some examples, a proximity to a first of the pair of nodes depends on a number of employees leaving the second company, of the pair of companies, to join the first company, of the pair of companies, divided by the number of employees leaving one of the pair of companies to join the other of the pair of companies. In the specific example of FIG. 2, talent flow icon 206 is positioned closer to company B than to company A, showing that more employees switched from company A to company B than switched from company B to company A, in the selected time frame. In some examples, the position away from halfway between two companies can be proportional to an imbalance in employee switching between the companies. In other examples, the visual representation 200 can optionally display an additional number, representing a net flow of talent.

A time frame selector 208 can allow a user to select a time frame through the user interface, such as a web browser. In some examples, the selected time frame can include a selected year and a selected month. For some of these examples, the talent flow data can be compiled on a month-by-month basis. In some examples, a user can select a time frame, and visual representation 200 can include animation that can resize and reposition the nodes 202A-C (and edges 204 and talent flow icons 206) in month-to-month increments from a previously-selected time frame to the selected time frame. In some examples, time frame selector 208 can include a clickable play button, which can trigger animation between two selected time frames. The play button can show time-evolution of elements in the visual representation 200. In some examples, once clicked, the play button can become a pause button, which can pause the animation, and allow a user to zoom into particular detail in the visual representation 200, and/or select and move the elements in the visual representation 200 to more closely observe a particular element or elements.

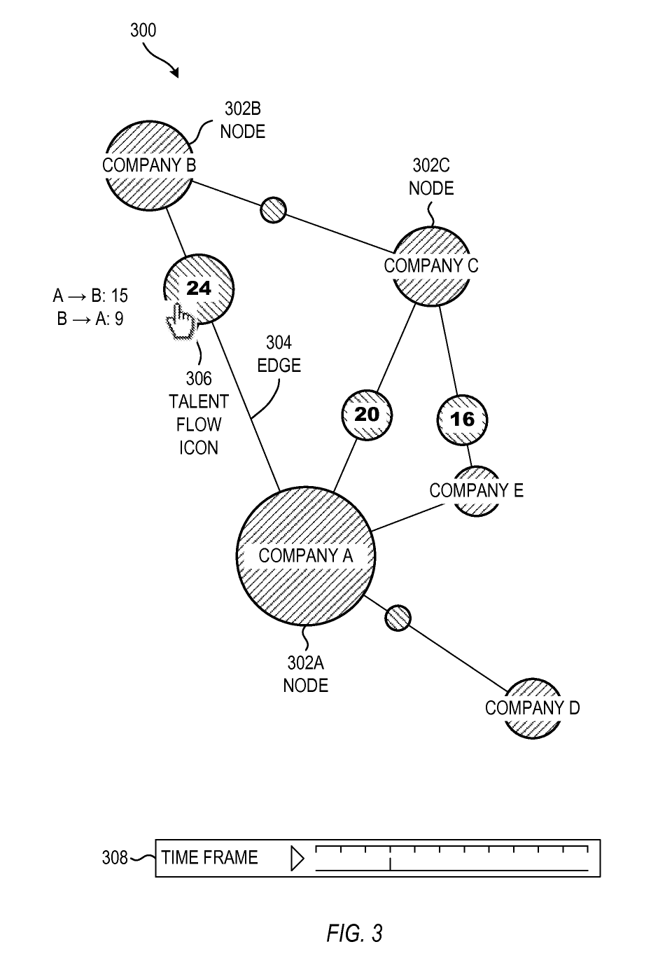

Various elements in the visual representation 200 can be interactive. FIGS. 3-5 show examples of responses of the visual representation 200 to cursor hovering and cursor clicks.

FIG. 3 shows an example of a visual representation 300 responding to a cursor hovering over a talent flow icon 306, in accordance with some examples. Nodes 302A-C, edge 304, and time frame selector 308 can be identical in structure and function to nodes 202A-C, edge 204, and time frame selector 208 from FIG. 2. This is but one example; other suitable examples can also be used.

In response to the cursor hovering over talent flow icon 306, visual representation 300 can display numerically how many employees left a first of the pair of companies to join a second of the pair of companies, in the selected time frame, and can display numerically how many employees left the second of the pair of companies to join the first of the pair of companies, in the selected time frame.

In the specific example of FIG. 3, in response to the cursor hovering over talent flow icon 306, visual representation 300 displays “A→B: 15”, indicating that in the selected time frame, 15 employees left company A to join company B. Similarly, visual representation 300 also displays “B→A: 9”, indicating that in the selected time frame, 9 employees left company B to join company A.

When the cursor is move away from talent flow icon 306, visual representation 300 can remove the numerical display and return to the appearance of visual representation 200 (FIG. 2).

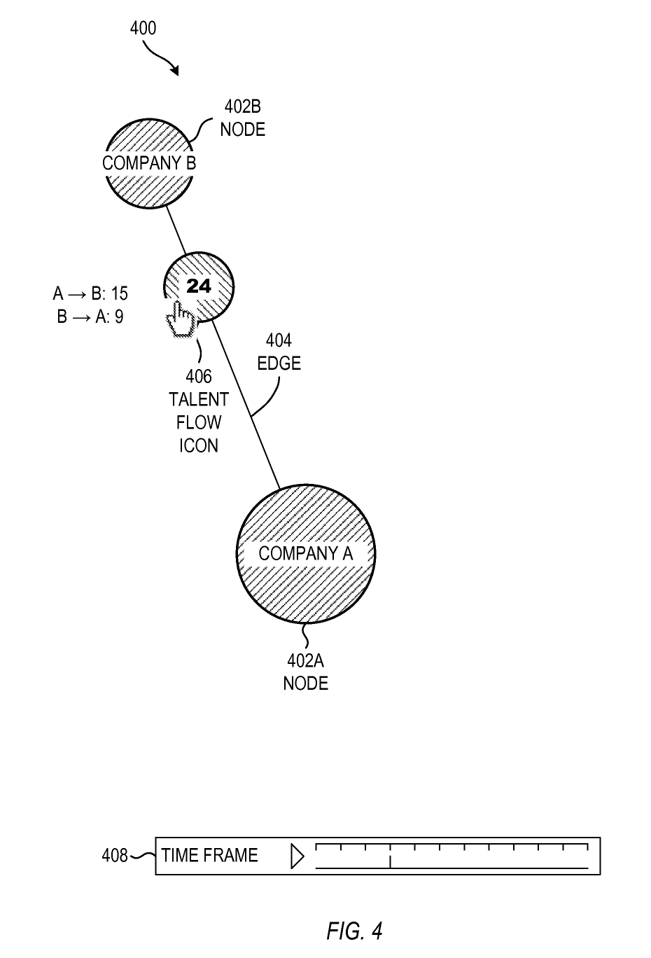

FIG. 4 shows an example of a visual representation 400 responding to a cursor clicking on a talent flow icon 406, in accordance with some examples. Nodes 402A-B, edge 404, and time frame selector 408 can be identical in structure and function to nodes 202A-B, edge 204, and time frame selector 208 from FIG. 2. This is but one example; other suitable examples can also be used.

In response to the cursor clicking on talent flow icon 406, visual representation 400 can remove all nodes except the pair of nodes 402A-B corresponding to the talent flow icon 406, and can remove all edges except the edge 404 corresponding to the talent flow icon 406. The numerical display of numbers of employees exchanged (see FIG. 3) can remain in visual representation 400 when the cursor clicks on talent flow icon 406. In other examples, in response to the cursor clicking on talent flow icon 406, visual representation 400 can increase a transparency of all nodes except the pair of nodes 402A-B corresponding to the talent flow icon 406, which can gray out the other nodes. In some examples, clicking on a talent flow icon 406 can zoom into the clicked icon 406.

In some examples, when the cursor click is released, visual representation 400 can replace the removed nodes and edges, and return to the appearance of visual representation 200 (FIG. 2).

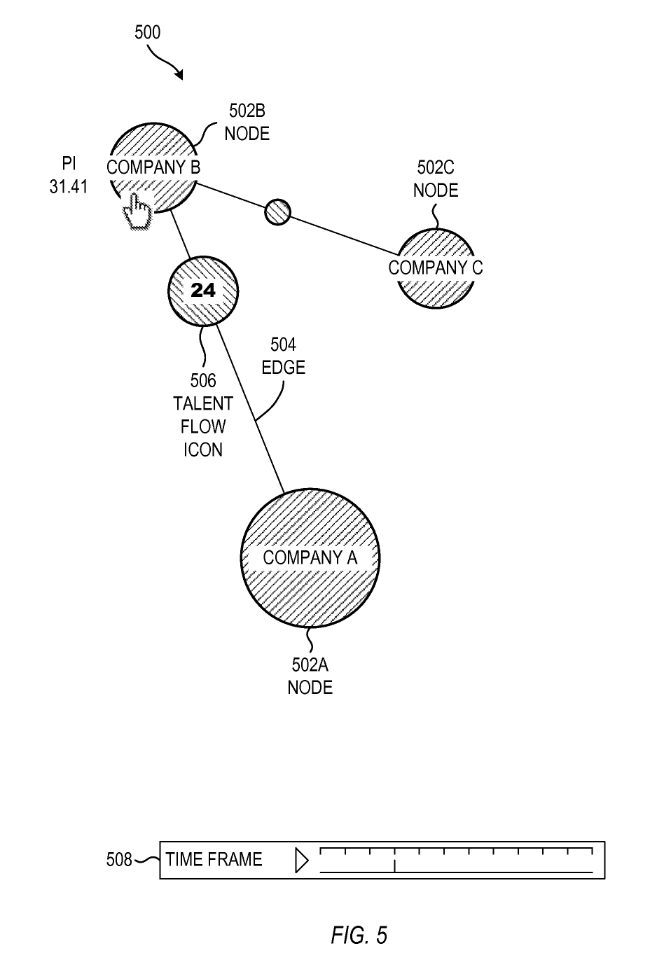

FIG. 5 shows an example of a visual representation 500 responding to a cursor hovering over a node, in accordance with some examples. Nodes 502A-C, edge 504, and time frame selector 508 can be identical in structure and function to nodes 202A-C, edge 204, and time frame selector 208 from FIG. 2. This is but one example; other suitable examples can also be used.

In response to the cursor hovering over a first node 502B corresponding to a first company (e.g., company B in FIG. 5), visual representation 500 can remove all nodes except those corresponding to companies that exchanged employees directly with the first company, in the selected time frame. In the example of FIG. 5, visual representation 500 keeps companies A and C, because companies A and C exchanged one or more employees with company B in the selected time frame, and removed companies D and E, because companies D and E did not exchange any employees with company B in the selected time frame.

In response to the cursor hovering over the first node 502B corresponding to the first company, visual representation 500 can further display stock information about the first company. For instance, stock information can include one or more of an exchange name, an exchange symbol, a stock price in the selected time frame, a current stock price, and so forth. In the specific example of FIG. 5, visual representation 500 displays an exchange name of PI, and a stock price of 31.41, for company B.

When the cursor is moved away from the node 502B, visual representation 500 can replace the removed nodes and edges and remove the numerical display, and return to the appearance of visual representation 200 (FIG. 2).

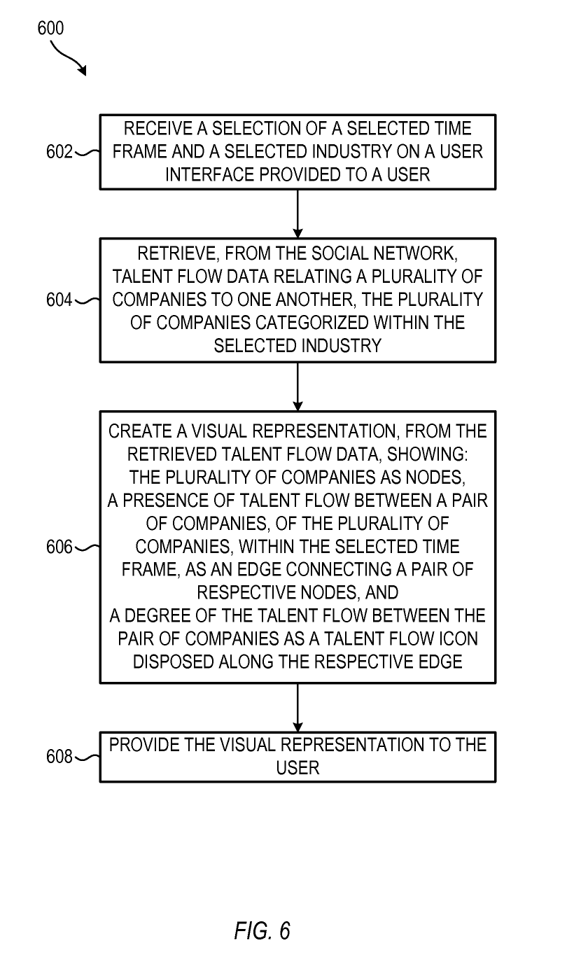

FIG. 6 shows an example of a method 600 for visually displaying talent flow among companies, where the companies have employees that are members of a social network, in accordance with some examples. The method 600 may be executed on at least one computer processor in the social networking service 100 of FIG. 1, or on other suitable computer processors or other suitable social networking services. The method 600 is but one example, and other suitable methods for visually displaying relationships among companies may also be used.

At operation 602, the at least one computer processor may receive a selection of a selected time frame and a selected industry on a user interface provided to a user.

At operation 604, the at least one computer processor may retrieve, from the social network, talent flow data relating a plurality of companies to one another, the plurality of companies categorized within the selected industry.

At operation 606, the at least one computer processor may create a visual representation, from the retrieved talent flow data, showing: the plurality of companies as nodes, a presence of talent flow between a pair of companies, of the plurality of companies, within the selected time frame, as an edge connecting a respective pair of nodes, and a degree of the talent flow between the pair of companies as a talent flow icon disposed along the respective edge.

At operation 608, the at least one computer processor may provide the visual representation to the user.

In some examples, in response to a cursor hovering over the talent flow icon, the visual representation may display numerically how many employees left a first of the pair of companies to join a second of the pair of companies, in the selected time frame, and may display numerically how many employees left the second of the pair of companies to join the first of the pair of companies, in the selected time frame.

In some examples, in response to a cursor clicking on the talent flow icon, the visual representation may remove all nodes except the pair of nodes, and may remove all edges except the respective edge.

In some examples, in response to a cursor hovering over a first node corresponding to a first company, the visual representation may remove all nodes except those corresponding to companies that exchanged employees directly with the first company, in the selected time frame.

In some examples, in response to the cursor hovering over the first node corresponding to the first company, the visual representation may further display stock information about the first company, such as an exchange name, an exchange symbol, a stock price at the selected time frame, and/or a current stock price.

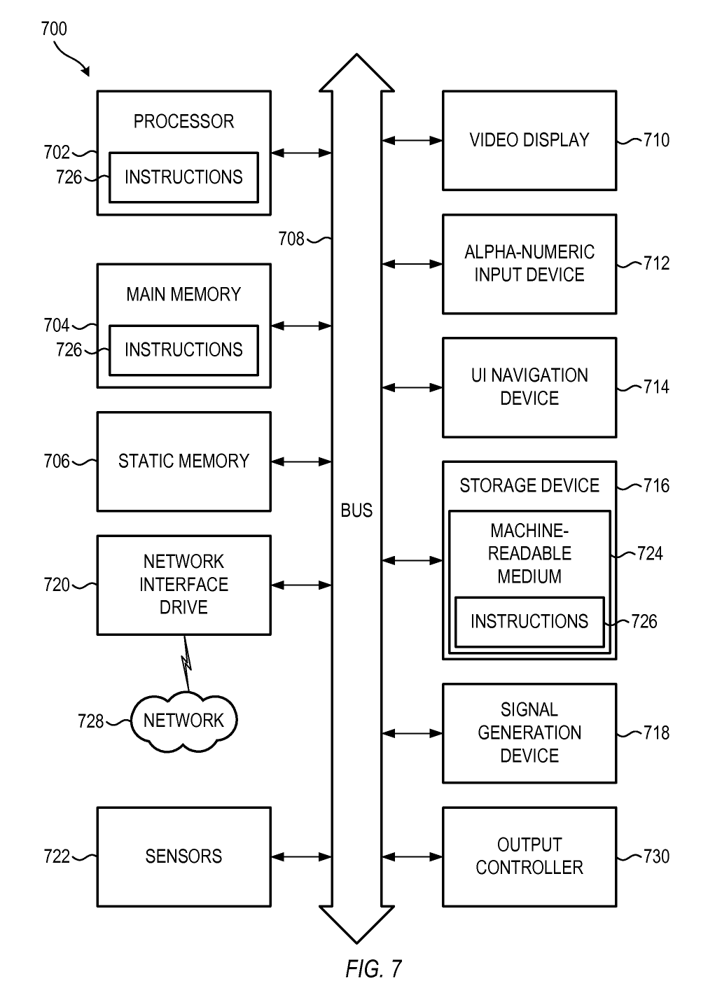

FIG. 7 illustrates a block diagram of an example of a machine 700 upon which any one or more of the techniques (e.g., methodologies) discussed herein may perform. The components of FIG. 1 may execute upon and/or include one or more of the components in FIG. 7. In alternative examples, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a server, personal computer (PC), a tablet PC, a set-top box (STB), a personal digital assistant (PDA), a mobile telephone, a smart phone, a web appliance, a network router, switch or bridge, a component of a social networking service, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules include a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 722, such as a global positioning system (GPS) sensor, compass, accelerometer, or other sensor. The machine 700 may include an output controller 730, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 724 on which is stored one or more sets of data structures or instructions 726 (e.g., software) embodying or utilized by any one or more of the techniques or functions described herein. The instructions 726 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 724 is illustrated as a single medium, the term “machine readable medium” may include a single medium or multiple media (e.g., a centralized or distributed database, and/or associated caches and servers) configured to store the one or more instructions 726.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 726 may further be transmitted or received over a communications network 728 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 728. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

What is claimed is:

1. A method for visually displaying talent flow among companies, the companies having employees that are members of a social network, the method comprising:
using at least one computer processor to:
receive a selection of a selected time frame and a selected industry on a user interface provided to a user;
retrieve, from the social network, talent flow data relating a plurality of companies to one another, the plurality of companies categorized within the selected industry;
create a visual representation, from the retrieved talent flow data, showing:
the plurality of companies as nodes,
a presence of talent flow between a pair of companies, of the plurality of companies, within the selected time frame, as an edge connecting a respective pair of nodes, and
a degree of the talent flow between the pair of companies as a talent flow icon disposed along the respective edge; and
provide the visual representation to the user.

2. The method of claim 1, wherein the nodes are sized according to company size at the time of the selected time frame.

3. The method of claim 1, wherein the plurality of companies represents the largest companies in the selected industry at the time of the selected time frame.

4. The method of claim 1, wherein each talent flow icon is sized according to an aggregate number of employees exchanged between the pair of companies, in the selected time frame.

5. The method of claim 1, wherein each talent flow icon is positioned along the respective edge in a position that indicates an aggregated direction of talent flow between the pair of companies, in the selected time frame.

6. The method of claim 1, wherein the talent flow data is compiled from profiles of the members of the social network.

7. The method of claim 1, wherein:
the nodes are shaded with a first color; and
the talent flow icons are shaded with a second color, different from the first color.

8. The method of claim 1, wherein in response to a cursor hovering over the talent flow icon, the visual representation:
displays numerically how many employees left a first of the pair of companies to join a second of the pair of companies, in the selected time frame; and
displays numerically how many employees left the second of the pair of companies to join the first of the pair of companies, in the selected time frame.

9. The method of claim 8, wherein in response to a cursor clicking on the talent flow icon, the visual representation:
removes all nodes except the pair of nodes; and
removes all edges except the respective edge.

10. The method of claim 1, wherein in response to a cursor hovering over a first node corresponding to a first company, the visual representation removes all nodes except those corresponding to companies that exchanged employees directly with the first company, in the selected time frame.

11. The method of claim 10, wherein in response to the cursor hovering over the first node corresponding to the first company, the visual representation further displays stock information about the first company.

12. The method of claim 1, wherein the selected time frame comprises a selected year and a selected month.

13. The method of claim 1, wherein, in response to a selection of a second selected time frame, the visual representation resizes and repositions the nodes in month-to-month increments from the selected time frame to the second selected time frame.

14. A social network system for visually displaying talent flow among companies, the companies having employees that are members of a social network, the system comprising:
at least one processor; and
memory, including instructions that, when executed on the at least one processor, cause the at least one processor to:
receive a selection of a selected time frame and a selected industry on a user interface provided to a user;
retrieve, from the social network, talent flow data relating a plurality of companies to one another, the plurality of companies categorized within the selected industry;
create a visual representation, from the retrieved talent flow data, showing:
the plurality of companies as nodes,
a presence of talent flow between a pair of companies, of the plurality of companies, within the selected time frame, as an edge connecting a respective pair of nodes, and
a degree of the talent flow between the pair of companies as a talent flow icon disposed along the respective edge; and
provide the visual representation to the user.

15. The system of claim 14, wherein:
each talent flow icon is sized according to an aggregate number of employees exchanged between the pair of companies, in the selected time frame; and
each talent flow icon is positioned along the respective edge to indicate an aggregated direction of talent flow between the pair of companies, in the selected time frame.

16. The system of claim 14, wherein the instructions comprise:
in response to a cursor hovering over the talent flow icon, the visual representation:
displays numerically how many employees left a first of the pair of companies to join a second of the pair of companies, in the selected time frame; and
displays numerically how many employees left the second of the pair of companies to join the first of the pair of companies, in the selected time frame.

17. The system of claim 16, wherein the instructions comprise:
in response to a cursor clicking on the talent flow icon, the visual representation:
removes all nodes except the pair of nodes; and
removes all edges except the respective edge.

18. The system of claim 14, wherein the instructions comprise:
in response to a cursor hovering over a first node corresponding to a first company, the visual representation removes all nodes except those corresponding to companies that exchanged employees directly with the first company, in the selected time frame.

19. A non-transitory machine-readable medium, including instructions, which when executed by the machine, cause the machine to perform operations for visually displaying talent flow among companies, the companies having employees that are members of a social network, the operations comprising:
receiving a selection of a selected time frame and a selected industry on a user interface provided to a user;
retrieving, from the social network, talent flow data relating a plurality of companies to one another, the plurality of companies categorized within the selected industry;
creating a visual representation, from the retrieved talent flow data, showing:
the plurality of companies as nodes,
a presence of talent flow between a pair of companies, of the plurality of companies, within the selected time frame, as an edge connecting a respective pair of nodes, and
a degree of the talent flow between the pair of companies as a talent flow icon disposed along the respective edge; and
providing the visual representation to the user.

20. The non-transitory machine-readable medium of claim 19, wherein the operations further comprise:
the selected time frame comprises a selected year and a selected month; and
in response to a selection of a second selected time frame, the visual representation resizes and repositions the nodes in month-to-month increments from the selected time frame to the second selected time frame.
